(19) United States
(12) Patent Application Publication
(10) Pub. No.: US 2022/0048806 A1
(43) Pub. Date: Feb. 17, 2022

(54) SYSTEM AND METHOD FOR HANDLING AND REMOVING A PERIPHERAL REGION OF A GLASS SHEET

(71) Applicant: Corning Incorporated, Corning, NY (US)

(72) Inventors: James William Brown, Painted Post, NY (US); Mark Thomas Massaro, Murray, KY (US); Naiyue Zhou, Painted Post, NY (US)

(21) Appl. No.: 17/312,651

(22) PCT Filed: Dec. 3, 2019
(86) PCT No.: PCT/US2019/064195

§ 371 Date: Jun. 10, 2021

Related U.S. Application Data
(60) Provisional application No. 62/778,357, filed on Dec. 12, 2018.

(51) Int. Cl. C03B 33/02; C03B 33/10; C03B 17/06; B65G 49/06

(52) U.S. Cl. CPC C03B 33/0215; C03B 33/105; B65G 2249/00; B65G 49/063; B65G 49/067; C03B 17/06

(57) ABSTRACT

A glass manufacturing system including a scoring assembly. The scoring assembly including a scoring device disposed along a first surface of a glass ribbon and a backing device disposed along a second surface of the glass ribbon directly opposite the scoring device. The scoring assembly is configured to delineate a peripheral region from a central region of the glass ribbon by forming a vertical score line along the first surface as the glass ribbon moves downward in a y-axial direction between the scoring device and the backing device.

### BACKGROUND

This application claims the benefit of priority under 35 U.S.C. § 119 of U.S. Provisional Application Ser. No. 62/778,357 filed on Dec. 12, 2018, the content of which is relied upon and incorporated herein by reference in its entirety.

### FIELD

The present disclosure relates generally to methods and systems for glass sheet handling and periphery finishing. In particular, the present disclosure relates to methods and systems for removing a peripheral region of a glass sheet.

### TECHNICAL BACKGROUND

Thin glass sheets have found use in many optical, electronic or optoelectronic devices, such as liquid crystal displays (LCD), organic light-emitting diode (OLED) displays, solar cells, as semiconductor device substrates, color filter substrates, coversheets, and the like. The thin glass sheets, having a thickness from several micrometers to several millimeters, may be fabricated by a number of methods, such as float process, fusion down-draw process, slot down-draw process, and the like.

In the forming process for making the glass sheets, the peripheral regions of the glass sheet are typically subjected to direct contact with solid surfaces such as edge rolls, pulling rolls, edge guiding rolls, and the like. Thus, the peripheral regions of both sides of an as-formed glass sheet obtained directly from the forming device, such as in the bottom-of-draw area of a fusion down-draw or slot down-draw process, sometimes called “bead”, tend to have lower surface quality than a central region of the major surfaces. In addition, depending on the specific forming device used, the peripheral regions (i.e., beads) tend to have different thickness and significantly higher thickness variation than the central region. The glass sheet is often scored to remove the peripheral regions from the central region to define a final product, or main sheet. Scoring entails cutting a groove, called a score line, partially through the thickness of the glass sheet, with the score line defining the general shape of the final product. Following the placement of scoring lines, the peripheral regions are separated from the main sheet along the score lines in a process commonly called breaking. The breaking of the scored glass sheet entails generating a fracture through the thickness of the glass sheet within the score line which propagates along the score line. As clarification, within the context of the disclosure, “breaking” refers to this fracturing along the score lines as opposed to the destruction of the glass sheet. The breaking defines the resulting edge of the main sheet.

As customers request larger and thinner glass sheets, the glass sheets have higher flexibility and it becomes increasingly difficult to move the sheets through the processing steps and remove the peripheral regions from the sheets without causing undesirable motion in the glass sheet. When a glass sheet is manufactured, an overhead conveyor or a robot can be used to transport the glass sheet from one point to another point in a glass manufacturing facility. When the glass sheet is vertically oriented (i.e., the major surfaces extend vertically), increased speeds for the carrier to transport the glass sheet and decreased glass thickness can increase a tendency for the glass sheet to “sail” when being transported vertically through the air causing the unsecured portion of the glass sheet to be moved through the air out of vertical and possible hitting and breaking against other objects. Also, motion in the center portion of the glass sheet can be caused when there is a long unsupported span in the middle of the glass sheet during transport. The glass sheet can possibly break or even fall off if the conveyor or robot causes too much motion or “sailing” in the glass sheet. Currently, in order to minimize sheet “sailing”, bottom edge guide mechanisms are employed to constrain the motion of the bottom edge of the vertical sheet while being transported by an overhead conveyor. In many cases, transport speed is limited to minimize sheet damage thereby limiting the process sheet to sheet cycle time.

The display market has shown increasing demand for large glass sheets and/or small thickness. Peripheral region, or bead, removal and transportation of the glass sheets through the bead removal process can be a significant challenge and an overall yield bottleneck in the glass sheet manufacture process. Embodiments of the present disclosure can reduce sheet to sheet cycle time, in particular, peripheral (i.e., bead) removal cycle time and within a single manufacturing line of a glass manufacturing system (e.g., instead of a partially split manufacturing line of concurrently identical operations).

### SUMMARY

One aspect of the present disclosure relates to a glass manufacturing system including a scoring assembly. The scoring assembly includes a scoring device disposed along a first surface of a glass ribbon and a backing device disposed along a second surface of the glass ribbon directly opposite the scoring device. The scoring assembly is configured to delineate a peripheral region from a central region of the glass ribbon by forming a vertical score line along the first surface as the glass ribbon moves downward in a y-axial direction between the scoring device and the backing device.

Another aspect of the present disclosure relates to a glass manufacturing process. The glass manufacturing process includes drawing a molten glass vertically downward to form a glass ribbon and forming a vertical score line in the glass ribbon with a scoring assembly as the glass ribbon moves vertically along the scoring assembly. The vertical score line delineates a peripheral region from a central region. The process also includes separating a length of the glass ribbon into a glass sheet as the glass ribbon moves vertically downward, engaging the glass sheet in a substantially vertical orientation with a glass sheet transfer device, transporting the substantially vertically oriented glass sheet from a first location to a debeader, releasing the substantially vertically oriented glass sheet from the glass sheet transfer device at the debeader, and removing the peripheral region from the glass sheet.

Another aspect of the present disclosure relates to a glass manufacturing system including a scoring assembly, a separation device, a debeader, and a glass sheet transfer device. The scoring assembly is configured to impart a vertical score line as a glass ribbon moves vertically along the scoring assembly. The separation device is configured to separate a glass sheet from the glass ribbon at a horizontal break line. The debeader is configured to separate a peripheral region from a central region of the glass sheet along the vertical score line. The glass sheet transfer device is configured to transfer the glass sheet in a substantially vertical orientation to the debeader. The glass sheet transfer device is configured to vertically stabilize the glass sheet glass during transfer.

Additional features and advantages of the embodiments disclosed herein will be set forth in the detailed description that follows, and in part will be readily apparent to those skilled in the art from that description or recognized by practicing the disclosure as described herein, including the detailed description which follows, the claims, as well as the appended drawings.

It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a block diagram of an example glass manufacturing system including a glass handling and peripheral region scoring and removal system in accordance with aspects of the present disclosure;

FIGS. 2A-2C illustrate schematic side and front views of an example scoring assembly useful in the glass manufacturing system of FIG. 1 in accordance with aspects of the present disclosure;

FIG. 3 is a perspective expanded schematic view of an example score head unit useful in the scoring assembly of FIGS. 2A-2C in accordance with aspects of the present disclosure;

FIG. 4 is a perspective expanded schematic view of an example backing roller useful in the scoring assembly of FIGS. 2A-2C in accordance with aspects of the present disclosure;

FIG. 5 is a perspective view of an example scoring assembly including the score head unit of FIG. 3 and the backing roller unit of FIG. 4 engaged with the glass ribbon in accordance with aspects of the present disclosure;

FIGS. 6A and 6B illustrate schematic side and front views of a scoring assembly including an example stabilizing assembly in accordance with aspects of the present disclosure; and

FIGS. 7A and 7B are front and side schematic views of the example glass handling and breaking system useful in the glass manufacturing system of FIG. 1 in accordance with aspects of the present disclosure.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

As used herein, “molten glass” shall be construed to mean a molten material which, upon cooling, can enter a glassy state. The term molten glass is used synonymously with the term “melt”. The molten glass may form, for example, a majority silicate glass, although the present disclosure is not so limited.

As used herein, the term “fluid” shall denote any gas, mixture of gasses, liquid, gas and liquid mixtures, vapor, or combinations thereof.

As used herein, the term “refractory”, or “refractory material” is used to denote non-metallic materials having chemical and physical properties that make them applicable for structures, or as components of systems, that are exposed to environments above about 538° C., for example equal to or greater than about 700° C., such as equal to or greater than about 800° C.

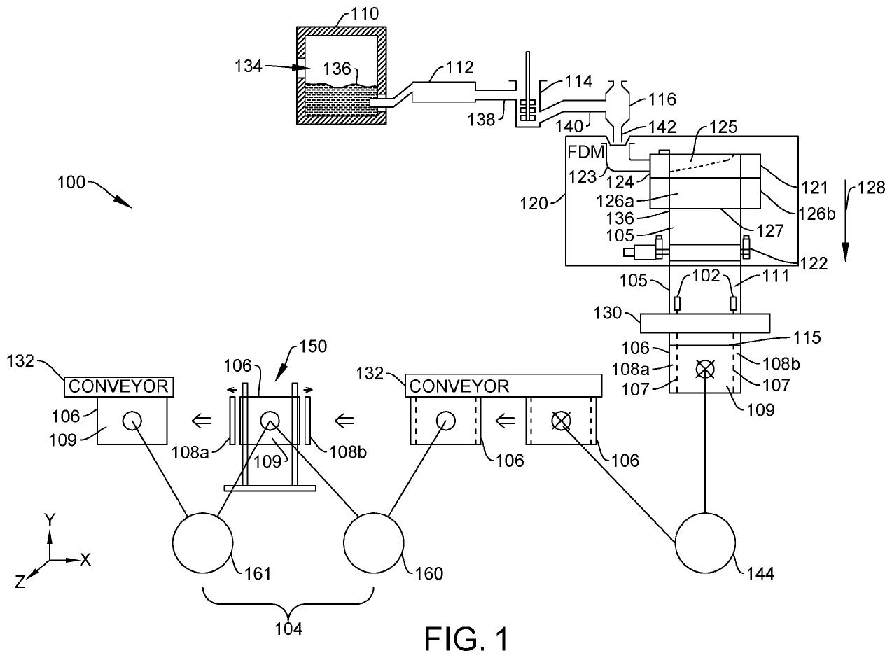

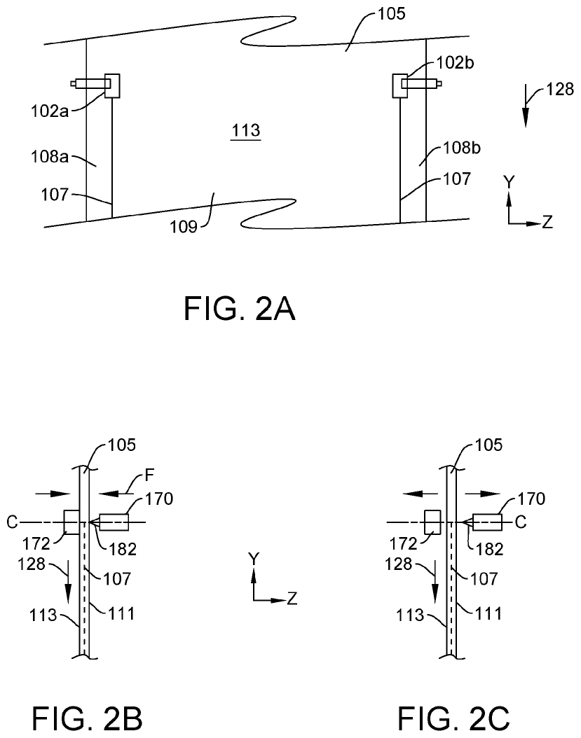

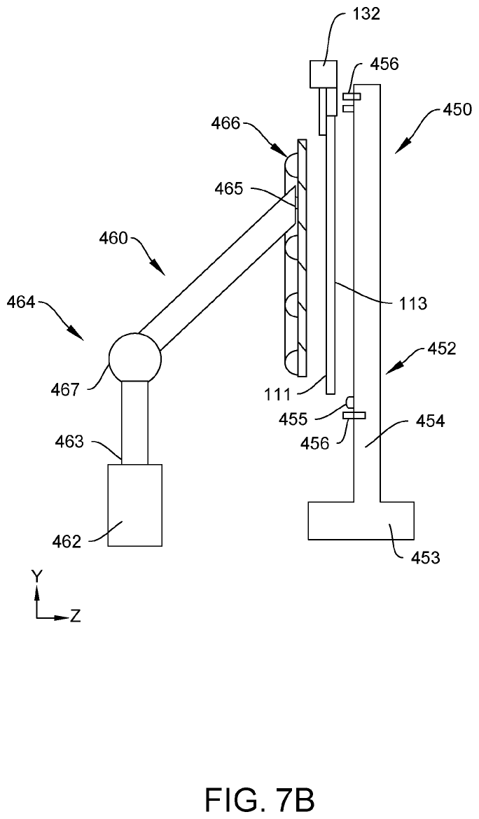

FIG. 1 is a diagram of an example glass manufacturing system 100 that uses the fusion draw-down glass forming process including a peripheral scoring assembly 102 and glass handling and breaking system 104 to fabricate a glass sheet 106 in accordance with aspects of the present disclosure. As shown, the glass manufacturing system 100 includes a melting vessel 110, a fining vessel 112, a mixing vessel 114 (e.g., stir chamber 114), a delivery vessel 116 (e.g., bowl 116), a fusion draw down machine (FDM) 120, the scoring assembly 102, a separation device (e.g., traveling anvil machine (TAM)) 130, a conveyor 132, and the glass handling and breaking system 104. The glass handling and breaking system 104 includes a glass sheet transfer device 160, a debeader 150, in some embodiments, and a second glass sheet transfer device 161. A detailed discussion about the operation and different components of the scoring system 102 is provided below with respect to FIGS. 2A-6B. A detailed discussion about the operation and different components of the glass handling and breaking system 104 is provided below with respect to FIGS. 7A-7B.

With reference to FIG. 1, the melting vessel 110 is where the glass batch materials are introduced as shown by arrow 134 and melted to form molten glass 136 from the melting vessel 110 and in which bubbles are removed from the molten glass 136. The fining vessel 112 (e.g., finer tube 112) has a high temperature processing area that receives the molten glass 136 (not shown at this point) from the melting vessel 110 and in which bubbles are removed from the molten glass 136. The fining vessel 112 is connected to the mixing vessel 114 (e.g., stir chamber 114) by a finer to stir chamber connecting tube 138. The mixing vessel 114 is connected to the delivery vessel 116 by a connecting tube 140. The delivery vessel 116 delivers the molten glass 136 through a downcomer 142 into the FDM 120 which includes a forming vessel 121 (e.g., isopipe 121), and a pull roll assembly 122. As shown, the molten glass 136 from the downcomer 142 flows into an inlet 123 which leads to the forming vessel 121 (e.g., isopipe 121).

The forming vessel 121 includes an opening 124 that receives the molten glass 136 which flows into a trough 125 and then overflows and runs down two sides 126a and 126b before fusing together at what is known as a root 127. The root 127 is where the two sides 126a and 126b come together and where the two overflow walls of molten glass 136 rejoin (e.g., refuse) to form a ribbon 105 before being drawn downward by the pull roll assembly 122 to form the glass sheet 106. A single ribbon 105 of molten glass 136 that is drawn in a draw direction 128 (i.e., y-axial direction) from the root 127 by applying a downward tension to the glass ribbon 105, such as by gravity and the pull roll assembly 122, to control the dimensions of the glass ribbon 105 as the molten glass 136 cools and a viscosity of the material increases. Accordingly, the glass ribbon 105 goes through a visco-elastic transition and acquires mechanical properties that give the glass ribbon 105 stable dimensional characteristics. The glass ribbon 105 can be separated into individual glass sheets 106 by the separation device 130 in an elastic region of the glass ribbon 105 for further processing. Peripheral regions 108a, 108b are formed vertically along opposing edges of the glass ribbon 105. The pull roll assembly 122 can be positioned along opposing peripheral regions 108a, 108b of the glass ribbon 105.

With continued reference to FIG. 1, in one embodiment, the peripheral scoring can be implemented with the scoring assembly 102 disposed between the FDM 120 and the separation device 130 to create the score line 107 along the glass ribbon 105. The horizontal scoring and the sheet separation process via the separation device 130 can be completed in conjunction with the peripheral scoring process via the scoring assembly 102. The scoring assembly 102 is shown between the FDM 120 and the separation device 130 in FIG. 1. In one embodiment, the scoring assembly 102 is disposed above (i.e., y-axial direction) the separation device 130 to create a score force approximately one meter (m) above the cross-cut score line 115 when the glass sheet 106 is separated from the glass ribbon 105. Alternatively, the scoring assembly 102 can be disposed on separation device 130, as discussed further below. In either embodiment, the vertical scoring occurs while the glass ribbon 105 is still hot (substantially above room temperature) giving a wider process window for higher coefficient of thermal expansion (CTE) thereby imparting less stress on the glass ribbon 105 thereby making the process more reliable. In one embodiment, the cross-cut (i.e., horizontal, x-axial direction) scoring via the separation device 130 and the peripheral (i.e., vertical, y-axial direction) scoring via the scoring assembly 102 can occur on the same surface (e.g., first major surface 111) of the glass ribbon 105. In another embodiment, the cross-cut scoring and the peripheral scoring occur on opposite surfaces, 111 and 113, of the glass ribbon 105.

In another embodiment, peripheral scoring via scoring assembly 102 can occur immediately after the cross-cut scoring and breaking via the separation device 130. The scoring assembly 102 is mounted onto the separation device 130 (or scoring nosing). As with other embodiments, the separation device 130 can track, or move vertically with, the ribbon 105 as it moves downward and as the sheet 106 is snapped off, or separated from, the ribbon 105. Once the separation device 130 is signaled by the PLC to move upward after the snap off of the sheet 106, the scoring assembly 102 is triggered to engage the ribbon 102 to form the score line 107 on the ribbon 105 as the separation device 130 moves upward. The scoring assembly 102 is engaged until the desired length of the ribbon 105 is moved downward through and then disengaged. In this manner, the vertical scoring is completed independent of the cross-cut and sheet separation and movement or vibrations from the sheet separation process would not interact with the vertical scoring process.

The peripheral regions 108a, 108b can have different thickness (i.e., in the z-axial direction) and properties (e.g., texture) than a center, or main, region 109, at least partially due to contact with the pull roll assembly 140. The scoring assembly 102 can utilize the vertical motion of the glass ribbon 105 as it moves downward in the draw direction 128 via gravity and the pull roll assembly 122 through the fusion draw machine (FDM) 120 and down through below the separation device 130 area, imparting vertical score lines 107. The vertical score lines 107 can be imposed along a first surface 111 or an opposing second surface (not shown) of the glass ribbon 105. Scoring assemblies 102a, 102b can be positioned along each peripheral region 108a, 108b, or vertical bead edges, respectively.

The separation device 130 horizontally scores the drawn glass ribbon 105 to define distinct pieces of glass sheets 106. At this point, the glass sheet 106 is hot, significantly above room temperature. In one embodiment, a transport mechanism 144 (e.g., robot) then engages the cut glass sheet 106 and moves the glass sheet 106, in a vertical orientation, from the separation device 130 to the conveyor 132 which is located in a Bottom of the Draw (BOD) area. This area is referred to as the Hot BOD (HBOD) area as the glass sheet 106 is still hot. In general, the conveyor 132 can then convey the vertically oriented glass sheet 106, as it cools, through one or more subsequent process steps.

The glass sheet 106 is transported from the separation device 130 area with the peripheral regions 108a, 108b still attached to the central region 109, as delineated by the score lines 107. A glass sheet transfer device 160 of the glass handling and breaking system 104 can be used to engage and transfer the vertically oriented glass sheet 106 from a first station of the conveyor 132, as shown, to the debeader 150 of the glass handling and breaking system 104. The peripheral regions 108a, 108b are separated from the central region 109 at the debeader 150. After the peripheral regions 108a, 108b are removed, another glass sheet transfer device 161 can be employed to pick and transfer the central region 109 of the glass sheet 106, still vertically oriented, from the debeader 150 to a second station of the conveyor 132 for additional processing. At the end of the conveyor 132, which is referred to as the Cold End, the finished glass sheet 106 can be packaged along with other finished glass sheets 106 so they can be sent to customers.

FIGS. 2A-2C illustrate enlarged schematic front and side views of the example scoring assembly 102 useful in the glass manufacturing system 100 of FIG. 1 in accordance with aspects of the present disclosure. The score line 107 can be formed in the glass ribbon 105 by the scoring assembly 102 as the glass ribbon 105 moves downward and through or along the scoring assembly 102. The scoring assembly 102 can include scoring assemblies 102a, 102b to facilitate vertical scoring of the opposing peripheral regions 108a, 108b of the glass ribbon 105. The scoring assemblies 102a and 102b are functionally the same and may be generally referred to as the scoring assembly 102. The scoring assembly 102 includes a score head unit 170 and a backing roller unit 172.

As illustrated in FIGS. 2B and 2C, the glass ribbon 105 can pass between the backing roller unit 172 and the score head unit 170. In one embodiment, the score head unit 170 and the backing roller unit 172 of the scoring assembly 102 can be disposed and maintained at a predetermined fixed vertical elevation (y-axial direction) between the FDM 120 and the separation device 130 (see, e.g., FIG. 1), aligned along the substantially same elevation line, such as indicated with line “C. The score head unit 170 and the backing roller unit 172 can operate cooperatively to engage with the glass ribbon 105 on opposing first and second surfaces 111, 113 to form the score lines 107. The score head unit 170 and the backing roller unit 172 can be selectively and cooperatively engaged with the opposing first and second major surfaces 111, 113 of the glass ribbon 105 (see, e.g., FIG. 2B) and disengaged from the opposing first and second major surfaces 111, 113 of the glass ribbon 105 (see, e.g., FIG. 2C). The backing roller unit 172 and the score head unit 170 can be adjustable in the z-axial direction to provide the desired force against the glass and the desired scoring depth of the score lines 107 during engagement with the glass ribbon 105, provide disengagement from the glass ribbon 105 when desired. A scoring force, or a normal force (e.g., indicated by arrow “F” in FIG. 2B), can be applied by the score head unit 170 to cause engagement of the scoring wheel 182 with, and scoring of, the glass ribbon 105.

With reference to FIG. 2A, the backing roller unit 172 and the score head unit 170 can also be adjustable in the x-axial direction to provide for differing glass sheet 106 widths as well as to accommodate variances in the quality of the forming process. The downward movement of the glass ribbon 105 can rotatably move the backing roller 172 as the glass ribbon 105 passes vertically downward in a y-axial direction (indicated by arrow 128) along and against the backing roller 172. The score lines 107 can be used to define a breakline for subsequent removal of the peripheral regions 108a, 108b from the main region 109 of the glass sheet 106, defining a width (in the x-axial direction) of the finished glass sheet. Aspects of these features are described further below.

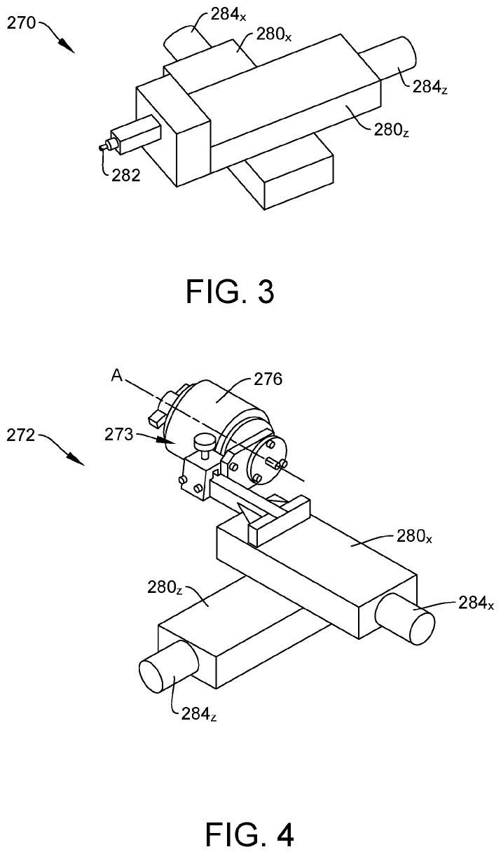

FIG. 3 is a perspective expanded schematic view of a score head unit 270 useful in a scoring assembly of the glass manufacturing system 100 of FIG. 1 in accordance with aspects of the present disclosure. Features of the score head unit 270 are similar to those of the score head unit 170 described above. In one embodiment, the scoring head unit 270 includes a scoring head, or scoring wheel, 282 can be selectively engaged with the first or second major surface 111, 113 of the glass ribbon 105 to form the score line 107. The scoring wheel 282 can be any scoring device appropriate to form the score line 107. The score head unit 270 is suitable to withstand the heat of the hot glass ribbon and function properly, in some embodiments, with the aid of thermal shielding, air cooling and score wheel 282 lubrication.

The score head unit 270 can control the force the score wheel 282 contacts and engages with the glass ribbon 105 (in the z-axial direction) to control the median crack depth along the score line 107 (see, e.g., FIGS. 2B-2C). The score head unit 270 can maintain the scoring wheel 282 to ribbon force with sufficient precision and force control to impart the desired score line 107 into the glass ribbon 105. The score head unit 270 can have x-axial (width) and z-axial (depth or ribbon thickness) slide units 280x, 280z, respectively. In one embodiment, the score head unit 270 can include the slide units 280x, 280z and force applying drives 284x, 284z, respectively, to apply force against the glass ribbon 105. The scoring wheel 282 can be mounted to the slide units 280x, 280z for selective engagement with the glass ribbon 105. A desired normal force “F” can be maintained at the scoring wheel 282 through the slide unit 280z and the force applying drive 284z to create a sufficient median crack. The slide units 280x, 280z can adjust and maintain the scoring wheel 282 in the desired position and apply sufficient and desired force to create the score/scribe median crack in the glass surface 111 that will allow separation of the peripheral region 108 from the central region 109 to occur under bending tensile stress later applied (e.g., at the debeader 150 of FIG. 1).

In one embodiment, the score head unit 270 can apply and control force using a compliant device such as a four bar linkage or “no friction” slide 280, or a servo drive slide, coupled to the force applying drive 284 (e.g., motor). As part of, or in addition to, the slide unit 280 and force applying drive 284, the score head unit 270 can include any of pneumatically driven cylinders, spring loading, torque limiting servo, voice coil actuators, or counter weights, or other appropriate mechanisms to aid control of force application, for example. In one embodiment, the score head unit 270 can be coupled to a servo control (not shown) to set the position along the x-axial direction and to properly set the position range along the z-axial direction to be within a desired force control range. In one embodiment, the scoring wheel 282 position is slidably adjustable using a servo control slide unit 280 connected to a Programming Logic Controller (PLC) to provide automatic programming of position and positioning changes (not shown). The slide unit 280 can be controlled through a direct current (DC) motor interface with the PLC, for example.

In one embodiment, the normal force (F or Fₙ) applied by the score head unit 270 can be increased as the scoring wheel 282 wears down from use. Factors in determining the appropriate scoring force to be applied by the score head unit 270 can include an outer diameter of the scoring wheel, scoring wheel angle relative to the surface of the glass, wheel type, glass ribbon moving speed along the scoring wheel, and glass thickness, for example. In general, scoring force will be increased for any one of increases to the diameter of the scoring wheel, the wheel angle, glass thickness, or speed of the ribbon through the scoring assembly. In one embodiment, the score head unit 270 can apply a normal force (Fₙ) unto the ribbon of 12 Newton (N), with an operating range of +/−6 N and force control of 0.1 N. A scoring force of 12 N can be employed for a diamond notched wheel such as the All Purpose In One (APIO®) scribing wheel manufactured by Mitsubishi Diamond Industrial Co., LTD (MDI) having a diameter of 2.5 millimeters (mm), wheel angle of 110 degrees (°), glass thickness of 0.5 mm and glass moving speed of 250 millimeters per second (mm/s) and Eagle™ XG glass. The scoring wheel 282 can also be formed with other suitable materials, such as tungsten carbide, for example.

In one embodiment, more than one scoring wheel 282 can be assembled onto a turret, for example (not shown), in order to provide for interchanging the scoring wheels 282. Interchanging of the scoring wheels 282 can be useful, for example, when a first score wheel 282 has been employed to a predetermined wear level through engagement with the surface of the glass ribbon 105 and is desirably exchanged (e.g., rotated out of use) and a second, unworn, scoring wheel 282 replaces the first, worn, scoring wheel 282. The score head unit 270 can include sensors to sense wear on the scoring wheel 282 and actuators to facilitate rotating and changing out of the worn scoring wheel 182 with an unworn scoring wheel 282 (not shown).

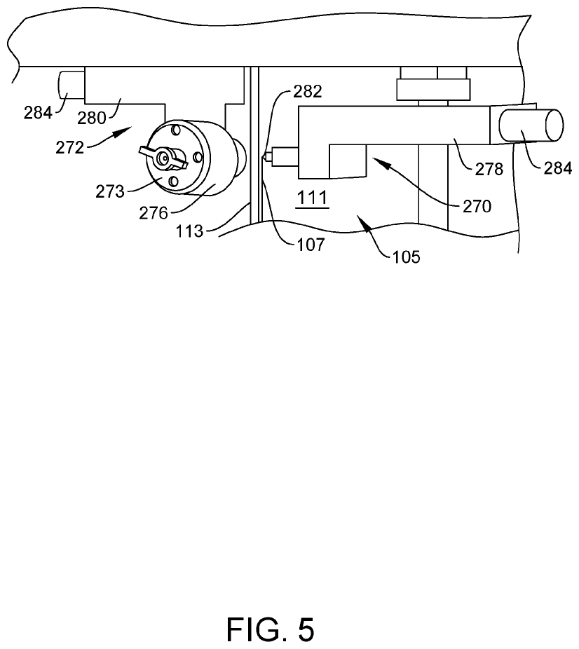

FIG. 4 is a perspective expanded schematic view of a backing roller unit 272 useful in a scoring assembly of the glass manufacturing system 100 of FIG. 1 in accordance with aspects of the present disclosure. Features of the backing roller 272 are similar to those of the backing roller 172 described above. The backing roller unit 272 can include a roller 273 having a contact surface 276 that can be selectively and rotatably engageable with the first or second surface 111, 113 of the glass ribbon 105. In one embodiment, the contact surface 276 can be cylindrical and rotatable about a central axis “A”. The backing roller unit 272 can provide a backing force against the surface 113, for example, to counter the applied normal force, Fₙ, of the scoring wheel 182 to the surface 111 and substantially maintain the glass ribbon 105 in a substantially vertical orientation along the z-axis during scoring. The backing roller unit 272 can be precisely positioned using a slide unit 278 (e.g., servo motor driven slide) and a force applying drive 284 (e.g., motor) to position it along the width of the glass ribbon (along the z-axis). In one embodiment, the backing roller unit 272 can have x-axial (width) and z-axial (depth or ribbon thickness) slide units 278x, 278z and force applying drives 284x, 284z, respectively. The slide units 278x, 278z of the backing roller unit 272 are similar to the slide units 280x, 280z of the score head unit 270. The backing roller unit 272 is suitable to withstand the heat of the hot glass ribbon and function properly, in some embodiments, with the aid of thermal shielding, air cooling and roller 283 lubrication.

Similar to the score head unit 270, more than one roller 273 can be assembled onto a turret, for example (not shown), for ease of interchanging the rollers 273 of the backing roller unit 272 and in order to provide an efficient exchange of the rollers 273. Interchanging of the rollers 273 can be useful, for example, when a first backing roller 273 has been employed to a predetermined wear level or lubrication level due to friction against the ribbon 105 and is desirably exchanged (e.g., rotated out of use) and a second (unworn) roller 273 replaces the first (worn) roller 273. Sensors can be employed to sense wear on the roller 273 and actuators can be employed to facilitate rotating and changing out of the worn roller 273 with an unworn roller 273 (not shown). Other mechanisms for suitably changing out the rollers 273 can also be used.

In one embodiment, the slide unit 280 of the backing roller unit 272 can apply and control force using a compliant device such as a four bar linkage or “no friction” slide, or a servo drive slide, coupled to the force applying drive 284 (e.g., motor). As part of, or in addition to, the backing roller unit 272 and force applying drive 284, the backing roller unit 272 can control force using any of pneumatically driven cylinders, spring loading, torque limiting servo, voice coil actuators, or counter weights, for example. In one embodiment, the backing roller unit 272 can be coupled to a servo control (not shown) to set the position along the x-axial direction and to properly set the position range along the z-axial direction to be within a desired force control range. In one embodiment, the roller 273 position is slidably adjustable using a servo control connected to a Programming Logic Controller (PLC) to provide automatic programming of position and positioning changes (not shown). The slide unit 278 can be controlled through a direct current (DC) motor interface with the PLC. The slide unit 278 can maintain the roller 173, or other appropriate score head device, in the desired position and apply sufficient and desired force to create the score/scribe median crack in the glass surface 113 that will allow separation of the peripheral region 108 from the central region 109 to occur under bending tensile stress later applied (e.g., at the debeader 150).

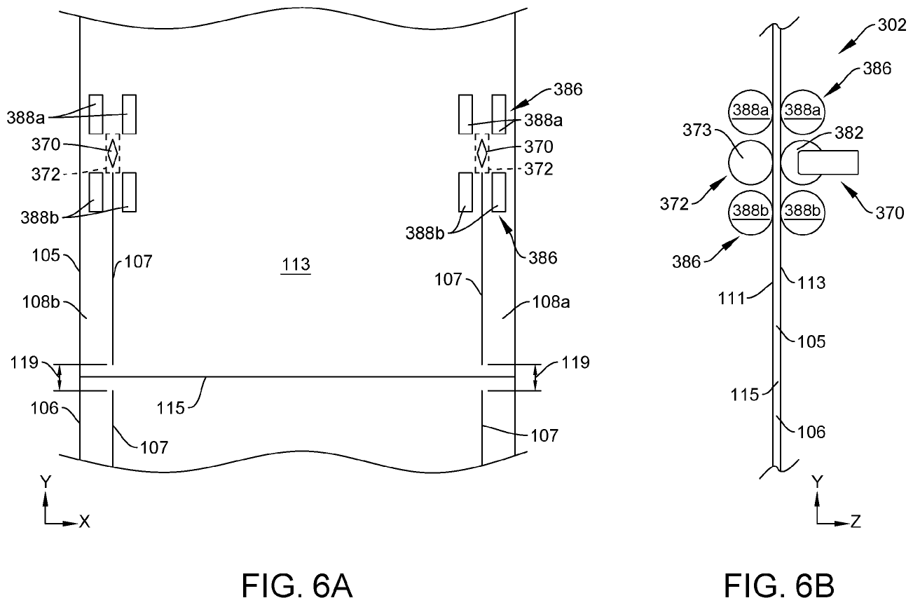

FIG. 5 illustrates a perspective view of the scoring assembly 202 including the score head unit 270 of FIG. 3 and the backing roller unit 272 of FIG. 4 engaged with the glass ribbon 105 in accordance with aspects of the present disclosure. The scoring head unit 270 can be disposed at a substantially same elevation (y-axial direction) opposite from the backing roller unit 272 is disposed along. More particularly, the roller 273 of the backing roller unit 272 and the scoring wheel 282 of the score head unit 270 can be positioned at an equivalent elevation along opposing surfaces of the glass ribbon 105. The backing roller 272 can engage the glass ribbon 105 on the major surface opposite the scoring wheel 282. The roller 273 can be selectively engaged with the surface 113 of the glass ribbon 105, such as when normal force is applied to the opposite surface 111 of the glass ribbon 105 by the score head unit 270. The backing roller 272 can be rotated to have the contact surface 276 move along with the speed of the ribbon (e.g., at equivalent speeds). The backing roller 273 can be precisely positioned using a servo motor driven slide to position it in the location of the desired cut width (along x-axis). The backing roller 272 can engage with the glass ribbon 105 in a non-quality area of the ribbon 105 that will be removed from the glass sheet 106 to form the final glass sheet product. The non-quality area can include the peripheral region 108a, 108b (see, e.g., FIG. 2A) and a perimeter border area inside the central region 109. For example, the contact surface 176 of the backing roller 272 can be sized and positioned to contact the ribbon 105 within a non-quality border area of approximately 10-20 mm inside the central region 109 of the glass sheet 106 from the score line 107.

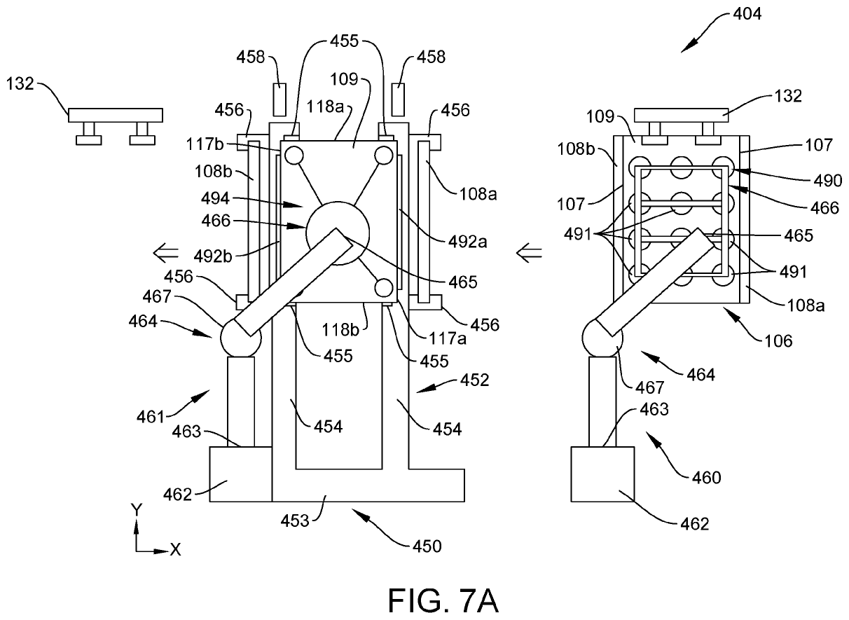

FIGS. 6A and 6B illustrate schematic side and front views of a scoring assembly 302 including a stabilizing assembly 386 positioned along a portion of the glass ribbon 105 in accordance with aspects of the present disclosure. In one embodiment, the stabilizing assembly 386 is included with the scoring assembly 302 to assist in stabilizing the ribbon 105 adjacent a scoring wheel 382. The stabilizing assembly 386 can include stabilizers 388, such as stabilizing rollers, positioned along the ribbon 105 adjacently above, below, or a combination of above and below the score head unit 370.

As illustrated in the side view of FIG. 6B, the stabilizing assembly 386 can include stabilizers 388a, 388b disposed along each of the first and second surfaces 111, 113 of the glass ribbon 105. In one example, the stabilizing rollers 388 are disposed approximately 25 mm to 50 mm vertically offset (i.e., along the y-axis) from the scoring wheel 382. The stabilizing assembly 386 including stabilizing rollers 388a above the score head unit 302 can assist with securing the ribbon position and segregate the peripheral scoring process from the ribbon 105 forming process as it occurs above the score head unit 302. The stabilizing assembly 386 including stabilizing rollers 388b below the score head unit 302 can assist in segregating the y-axis cross cut off process (e.g., via the separation device 130 of FIG. 1) from the peripheral scoring process. The stabilizing rollers 388a, 388b can be configured to rotate at a speed to substantially equal the speed of the ribbon 105 moving downward or, in some processes, slightly faster than the vertical movement speed of the ribbon 105 in order to assist in preventing the scoring process force from transmitting into the ribbon 105 motion and create a speed change or buckling of the ribbon 105. Stabilization rollers 388a, 388b positioned below the score head unit 302 can assist in preventing or limiting perturbation from the peripheral scoring process (e.g., vibration of the ribbon 105 caused during the cross-cut scoring and snap off process). In another embodiment, the scoring assembly 302 is mounted to the separation device 130 and cooperatively moves with the separation device 130 to form the vertical score lines 107 and the horizontal score line 115. When mounted to the separation device 130, the stabilizing rollers 338b can be eliminated due to the breaking of the sheet 106 from the glass ribbon 105 occurring when the score head unit 370 is disengaged from the glass ribbon 105.

With reference to FIG. 6A, in one embodiment, the peripheral scoring line 107 is nearly continuous with the exception of short unscored sections 119 (e.g., approximately 30 millimeters (mm)) adjacent to the cross-cut scoring line 115, or crossing out area. The scoring wheel 382 (and roller 373) can be disengaged from the ribbon approximately 15 mm before the “end” of the prescribed length of a first sheet and re-engage the ribbon at about 15 mm after the start of the next sheet. In other words, the scoring wheel 382 can be disengaged for a distance of approximately 15 mm before and after the cross-cut score line 115. In one embodiment, the scoring assembly 302 is disposed above the separation device 130 to create a score force approximately 500 mm above the forming of horizontal cross-cut score line 115. The unscored section 119 can assist with forming a well-defined breaking lines at both the score lines 107 and the cross-cut score line 115 and assist with controlling self-propagation of crack lines when breaking and separating the glass sheet 106 from the ribbon 105 at the horizontal cross-cut score line 115. The unscored sections 119 are interruptions in the peripheral score line 107 that can assist in preventing the median crack from growing or the peripheral regions 108a, 108b, or beads, from separating from the central region 109 during the snap off motion of the sheet 106 and transporting and handing off of the sheet 106 by the transport mechanism 144 to the conveyor 132 (see also, e.g., FIG. 1). The unscored sections 119 can assist with maintaining the peripheral regions 108a, 108b attached, or connected to, the central region 109 during the breaking and separating of the glass sheet 106 from the ribbon 105 at the horizontal cross-cut score line 115. The interruptions of the peripheral score line 107 at the unscored sections 119 can occur in order that the as-scored glass sheet 106 is more durable for transport to the debeader 150. The unscored sections 119 of the peripheral score line 107 can also allow a process interruption to occur which can be used for the scoring wheel 182 change, cleaning and/or lubrication to be completed. For example, the scoring wheel 382 and/or roller 373 can be replaced or repaired while disengaged.

FIGS. 7A and 7B are front and side schematic views of an example glass handling and breaking system 404 useful in the glass manufacturing system 100 of FIG. 1 in accordance with aspects of the present disclosure. The glass handling and breaking system 404 includes the first glass sheet transfer device 460, the debeader 450, and the second glass sheet transfer device 461, as described further below. The glass handling and breaking system 404 is positioned after, or downstream from, the scoring assembly 102 and the separation device 130 in the manufacturing line of the glass manufacturing system 100 (see, e.g., FIG. 1). With additional reference to FIG. 1, the glass sheet 106 is transported from the separation device 130 area (via transport mechanism 144 and conveyor 132) with the peripheral regions 108a, 108b still attached to the central region 109, as delineated by the score lines 107. The glass handling and breaking system 404 can be employed to facilitate efficient transportation of the glass sheet 106 and removal of the scored peripheral regions 108a, 108b (i.e., bead edges) from the center portion 109.

The first glass sheet transfer device 460 of the glass handling and breaking system 404 can be used to engage and transfer the vertically oriented glass sheet 106 from the first station of the conveyor 132 to the debeader 450 of the glass handling and breaking system 404. In one embodiment, the first glass sheet transfer device 460 is positioned and oriented to engage the glass sheet 106 along a single surface, for example, the first surface 111. In one embodiment, the first glass sheet transfer device 460 can alternatively or additionally engage the glass sheet 106 along the peripheral non-quality border areas (e.g., left and right side edges 117a, 117b) of the glass sheet 106. In one embodiment, the left and right side edges 117a, 117b can include the peripheral regions 108a, 108b when attached to the center portion 109. The first glass sheet transfer device 460 transfers the vertically oriented glass sheet 106 to the debeader 450, releasing and disengaging from the first surface 111, for example, of the glass sheet 106 upon engagement of the glass sheet 106 to the debeader 450. The debeader 450 is oriented to engage the glass sheet 106 along the second surface 113, opposite the first surface 111, and/or peripheral non-quality border areas of the glass sheet 106 that the glass sheet transfer device 460 does not engage the glass sheet 106 (e.g., top and bottom side edges 118a, 118b). Similar to the first glass sheet transfer device 460, the second glass sheet transfer device 461 is positioned and oriented to engage the glass sheet 106 along the first surface 111 of the glass sheet 106. In one embodiment, the second glass sheet transfer device 461 can alternatively or additionally engage the glass sheet 106 along the peripheral non-quality border areas (e.g., left and right side edges 117a, 117b) of the glass sheet 106.

The glass sheet transfer devices 460, 461 are configured for repetitive motion (e.g., back and forth) between the conveyor pick or drop location and the debeader 450 to pick up, transport, and deposit vertically oriented glass sheets 106. The glass sheet transfer devices 460, 461 can each be a robot or other electro-mechanical carrier. The glass sheet transfer devices 460, 461 can vertically stabilize the glass sheet 106 during transport and limited undesired movement, such as sailing of the glass sheet 106 caused by to movement of the large planar glass sheet 106 through air. The glass sheet transfer devices 460, 461 is configured to engage the glass sheet 106 to limit undesired movement (e.g., sailing, movement at an angle to vertical, movement in more than one direction outside of the desired transfer path, undulations, etc.) of all or portions of the glass sheet 106 as it is transported in a vertical orientation.

In one embodiment, the glass sheet transfer devices 460, 461 can each include a base 462, an arm 464, and a glass sheet engagement assembly 466. The base 462 can be mobile or fixed in a predetermined location. For example, the base 462 can be bolted or otherwise fastened to a floor of a manufacturing facility along a manufacturing line. The arm 464 extends from the base 462 with a first end 463 coupled to the base 462 and a second end 465, opposite the first end 463, coupled to and terminating at the glass sheet engagement assembly 466. The arm 464 can also include one or more joints 467 between the first end 463 and the second end 465 to facilitate turning, rotating, or other multi-planar movements of the arm 464 between the base and the glass sheet engagement assembly 466. The arm 464 is configured to move the glass sheet engagement assembly 466 through space from a first location (e.g., the conveyor 132) to a second location (e.g., the debeader 450). The glass sheet engagement assembly 466 is configured to selectively engage with one surface 111, or 113 of the vertically oriented glass sheet 106. In one embodiment, the glass sheet engagement assembly 466 can include a set of interchangeable glass sheet engagement assemblies 466 of various sizes to be appropriate for engaging with different sizes of glass sheets 106.

The glass sheet transfer devices 460, 461 can be configured identically or differently in accordance with aspects of the present disclosure. For example, the first glass sheet transfer device 160 can include the same or different type glass sheet engagement assembly 466. In one embodiment, the glass sheet engagement assembly 466 of the first glass sheet transfer device 460 can include a suction assembly 490 configured to engage with the first surface 111 of the vertically oriented glass sheet 106 to vertically stabilize and limited undesirable movement of the vertically oriented glass sheet 106 during transport by the glass sheet transfer device 460. The suction assembly 490 can include one or more suction devices 491, or suction cups, arranged in a spaced apart pattern as appropriate to engage and support the glass sheet during transport. In one embodiment, the suction devices 491 can selectively engage with and cover a majority (more than 50%) of the surface area of the first surface 111.

In one embodiment, the glass sheet engagement assembly 466 can include edge grippers 492. For illustrative purposes, the edge grippers 492 are included with the second glass sheet transfer device 461, although it is understood that the edge grippers 492 can be included with the glass sheet engagement assembly 466 of the first glass sheet transfer device 460. The edge grippers 492 include a pair of opposing side edge grippers 492a, 492b configured to engage the vertically oriented glass sheet 106 at non-quality areas along opposing side edges 117a, 117b. In one embodiment, the edge grippers 492 are configured to engage and extend around the side edges 117a, 117b of the glass sheet 106 and adjacent non-quality areas of the first and second major surfaces 111, 113. The edge gripper 492 can include a nosing made of a flexible material, such as rubber, for example, to contact the glass sheet 106 without damaging the glass sheet 106. The edge grippers can be movable via a pneumatic actuator, servo, or other mechanism to move the edge grippers 492a, 492b toward and securely engage the edges 117a, 117b of the glass sheet 106, and outward, away from the edges 117a, 117b of the glass sheet 106 to disengage from and release the glass sheet 106 when appropriate.

In one embodiment, the glass sheet engagement assembly 466 can include aero-mechanical engagement members 494 as illustrated, for example, with the second glass sheet transfer device 461. The aero-mechanical engagement members 494 can be positioned along one major surface (e.g., first surface 111) of the vertically oriented glass sheet 106. In one embodiment, as illustrated, the glass sheet engagement assembly 466 can include edge grippers 492 and aero-mechanical engagement members 494. The aero-mechanical engagement members 494 can selectively support and stabilize the glass sheet 106 along a central region 109 to maintain the glass sheet 106 in a vertical plane and the edge grippers 492 can stabilize and support the glass sheet 106 along the side edges 117a, 117b. In another embodiment, the glass sheet engagement assembly 466 includes aero-mechanical engagement members and suction devices. For example, aero-mechanical engagement members can be positioned along the central region 109 of the glass sheet 106 and suction devices can be positioned to engage and support the vertically oriented glass sheet 106 around a perimeter portion of the glass sheet 106. One example of a glass sheet engagement assembly 466 including aero-mechanical engagement members 494 useful with the present disclosure is described in U.S. Pat. No. 7,260,959 to Chang et al., hereby incorporated by reference in its entirety.

The debeader 450 is configured to separate the peripheral regions 108a, 108b of the glass sheet 106 from the central region 109 along the existing vertical score lines 107. During the removal of the peripheral regions 108a, 108b from the central region 109, the glass sheet 106 can be selectively supported by and secured to a support stand 452 of the debeader 450. The support stand 452 can be any configuration suitable to support and secure the glass sheet 106 and facilitate ease of transfer from/to the glass sheet transfer devices 460, 461. By way of example, the support stand 452 can include a base 453, legs 454, and couplers 455. In one embodiment, the couplers 455 can be adjustable and/or articulating to accommodate engaging with and supporting various sizes and shapes of the glass sheet 106. In any regard, the debeader 450 can support and maintain the glass sheet 106 in a vertically oriented fixed position independent of the glass sheet transfer devices 460, 461. In one embodiment, the debeader 450 can be oriented along the second surface 113 of the glass sheet 106 to support the vertically oriented glass sheet 106 along the second surface 113 and/or non-quality areas of the second surface 113, such as the top and bottom edges 118a, 118b.

The debeader 450 can include breakers 456 to facilitate separating the peripheral regions 108a, 108b from the central region 109. In one embodiment, the breakers 456 can be articulating or otherwise movable in order that the glass sheet 106 can pass along one side (not between front and back components) of the debeader 450 during delivery and removal of the glass sheet 106. The elements of the breakers 456 or other components (e.g., couplers 455) of the debeader 450 can be either moved beyond the width of the beaded glass sheet 106, retracted behind or along the second surface 113 of the glass sheet 106, or otherwise positioned in order that the beaded glass sheet 106 can be placed directly onto and engaged with the support stand 452 of the debeader 450 from the glass sheet transfer device 160. The breaker 456 can be any movable mechanism suitable to facilitate separation of the peripheral regions 108b, 108b from the central region 109. The peripheral regions 108a, 108b can be snapped, broken, or otherwise disengaged from the central region 109 with the breakers 456. After the peripheral regions 108a, 108b are removed, another glass sheet transfer device 461 can be employed to pick and transfer the vertically oriented glass sheet 106 from the debeader 450 to the station of the conveyor 132 for additional processing.

In one embodiment, a vacuum source 458, or vacuum chamber, can be included at the debeader 450 to apply suction along the score lines 107. The vacuum source 458 can be positioned and oriented along score line 107 for particle capture and containment during separation process of the peripheral regions 108a, 108b. The absence of a scoring assembly at the debeader 450 (due to the scoring assembly 102 being located on or near the separation device 130) creates space for the vacuum source 458 without interference with a scoring assembly along the score lines 107. The vacuum source 458 can have clear access along the score lines 107 and does not need to be offset from the score line 107 and score area for effective removal of containment caused by the separation of the peripheral regions 108a, 108b from the central region 109.

The glass sheet transfer device 460 can be used to pick and transfer the vertically orientated glass sheet 106 from the conveyor 132 to the debeader 450. After the peripheral regions 108a, 108b are removed, the second glass sheet transfer device 461 can be used to pick and transfer the central region 109 of the glass sheet 106 from the debeader 450 to the second station, or section, of the conveyor 132. The glass sheet transfer device 461 on the downstream/outfeed side of the debeader 450 can pick up and transport the debeaded glass sheet in a vertical orientation (i.e., the central region 109) from the debeader 450 to a downstream location for transport of the vertically oriented glass sheet 106 by the conveyor 132 for additional processing.

The glass handling and breaking system 404 can facilitate simultaneous operation of the glass sheet transfer devices 460, 461 and the debeader 450. After releasing the glass sheet 106 at the debeader 450 for removal of the peripheral regions 108a, 108b, the arm 464 of the first glass sheet transfer device 460 can returned the glass sheet engagement assembly 466 to the first location of the conveyor 132 to engage and transport another glass sheet 106 from the conveyor 132. Meanwhile, the glass sheet engagement assembly 466 of the second glass sheet transfer device 461 can be returned or ready to engage and remove another glass sheet 106 at the debeader 450. The second glass sheet transfer device 461 can engage and transport the debeaded glass sheet 106 to the second station of the conveyor 132 after the debeading process is completed. In this manner, the operations of the glass sheet transfer devices 460, 461 and the debeader 450 can be simultaneous to transport and remove the peripheral regions 108a, 108b of multiple glass sheets 106. In another embodiment, instead of the first and second glass sheet transfer devices 460, 461, a single glass sheet transfer device 460 can facilitate the infeed and outfeed of an individual glass sheets to/from the debeader 450, repositioning as appropriate to facilitate efficient transfer of the glass sheets 106 before and after removal of the peripheral regions 108a, 108b. Regardless, the glass sheet transfer devices 460, 461 can transport the glass sheets 106, with or without the peripheral regions 108a, 108b, while maintaining the glass sheets 106 in a substantially planar and vertical orientation at speeds greater than otherwise obtainable with the conveyor 132. The simultaneous transportation, scoring and removal of the peripheral portions of multiple sheets can result in a reduction of overall sheet to sheet process cycle time over operations otherwise occurring in a series of sequential steps.

It will be apparent to those skilled in the art that various modifications and variations can be made to embodiments of the present disclosure without departing from the spirit and scope of the disclosure. Thus it is intended that the present disclosure cover such modifications and variations provided they come within the scope of the appended claims and their equivalents.

What is claimed is:

1. A glass manufacturing system, comprising:
a scoring assembly comprising:
a scoring device disposed along a first surface of a glass ribbon; and
a backing device disposed along a second surface of the glass ribbon directly opposite the scoring device,
wherein the scoring assembly is configured to delineate a peripheral region from a central region of the glass ribbon by forming a vertical score line along the first surface as the glass ribbon moves downward in a y-axial direction between the scoring device and the backing device.

2. The glass manufacturing system of claim 1, further comprising:
a separation device configured to separate a glass sheet from the glass ribbon at a horizontal break line, wherein the scoring assembly is disposed on the separation device.

3. The glass manufacturing system of claim 1, wherein the scoring assembly comprises:
a plurality of scoring devices arranged to interchangeably contact the glass ribbon.

4. The glass manufacturing system of claim 1, wherein the glass scoring assembly is maintained in a fixed position in the y-axial direction.

5. The glass manufacturing system of claim 1, further comprising:
a stabilizing assembly including at least one stabilizer disposed adjacent the scoring assembly, the at least one stabilizer disposed along both a first surface and an opposite second surface of the glass ribbon, the stabilizing assembly to maintain the glass ribbon along a z-axial direction.

6. The glass manufacturing system of claim 1, further comprising:
a debeader configured to separate the peripheral region of the glass sheet along the vertical score line; and
a glass sheet transfer device configured to maintain and transport the glass sheet having the vertical score line to the debeader, the glass sheet transfer device configured to stabilize the glass sheet in a vertical orientation during transport.

7. The glass manufacturing system of claim 6, wherein the glass sheet transfer device is configured to engage the glass sheet on a first surface and the debeader is configured to engage the glass sheet on a second surface of the glass sheet opposite the first surface.

8. A glass manufacturing process, comprising:
drawing a molten glass vertically downward to form a glass ribbon;
forming a vertical score line in the glass ribbon with a scoring assembly as the glass ribbon moves vertically along the scoring assembly, the vertical score line delineating a peripheral region from a central region;
separating a length of the glass ribbon into a glass sheet as the glass ribbon moves vertically downward;
engaging the glass sheet in a substantially vertical orientation with a glass sheet transfer device;
transporting the substantially vertically oriented glass sheet from a first location to a debeader;
releasing the substantially vertically oriented glass sheet from the glass sheet transfer device at the debeader; and
removing the peripheral region from the glass sheet.

9. The glass manufacturing process of claim 8, wherein the glass sheet transfer device engages the glass sheet on a first surface and the debeader engages the glass sheet on a second surface of the glass sheet opposite the first surface.

10. The glass manufacturing process of claim 8, further comprising:
returning the glass sheet transfer device to the first location after releasing the glass sheet at the debeader.

11. The glass manufacturing process of claim 8, further comprising:
engaging the central region of the glass sheet in a substantially vertical orientation with a second glass sheet transfer device at the debeader; and
transporting the central portion of the glass sheet in a substantially vertical orientation to a second station with the second glass sheet transfer device.

12. The glass manufacturing process of claim 8, wherein the step of vertically scoring the glass sheet further comprises:
positioning a backing device along a first surface of the glass ribbon;
positioning a scoring device along a second surface of the glass ribbon, the scoring device directly opposite the backing device; and
engaging the scoring device and the backing device against the glass ribbon with a predetermined force for a predetermined length of the glass ribbon.

13. The glass manufacturing process of claim 12, wherein the step of vertically scoring the glass sheet further comprises:
disengaging the scoring device and the backing device from the glass ribbon for a predetermined unscored length of the glass ribbon; and
re-engaging the scoring device and the backing device against the glass ribbon for the predetermined length of the glass ribbon.

14. The glass manufacturing process of claim 8, wherein the step of vertically scoring the glass sheet with the scoring assembly occurs prior to the step of separating a length of the glass ribbon.

15. The glass manufacturing process of claim 8, further comprising:
applying a vacuum source to the vertical score line at the debeader.

16. A glass manufacturing system, comprising:
a scoring assembly configured to impart a vertical score line as a glass ribbon moves vertically along the scoring assembly;
a separation device configured to separate a glass sheet from the glass ribbon at a horizontal break line;
a debeader configured to separate a peripheral region from a central region of the glass sheet along the vertical score line; and
a glass sheet transfer device configured to transfer the glass sheet in a substantially vertical orientation to the debeader, the glass sheet transfer device configured to vertically stabilize the glass sheet glass during transfer.

17. The glass manufacturing system of claim 16, wherein the scoring assembly is disposed on the separation device.

18. The glass manufacturing system of claim 16, wherein the scoring assembly is maintained in a fixed vertical position.

19. The glass manufacturing system of claim 16, wherein the glass sheet transfer device comprises a glass sheet engagement portion and a base, the base configured to support the glass sheet engagement portion, the base oriented to provide access of the glass sheet engagement portion to a first surface of the glass sheet, the glass sheet engagement portion movable between a first station and the debeader.

20. The glass manufacturing system of claim 16, further comprising:
a second glass sheet transfer device to remove the central region of the glass sheet from the debeader.
